(19) United States
(12) Patent Application Publication
(10) Pub. No.: US 2009/0280231 A1
(43) Pub. Date: Nov. 12, 2009

(54) PRO-OXIDANT SUGARS BALANCED WITH POLYPHENOLIC ANTIOXIDANTS

(76) Inventor: Daniel Perlman, Arlington, MA (US)

Correspondence Address: WESLEY B. AMES, 7031 LOS VIENTOS SERENOS, ESCONDIDO, CA, 92029, US

(21) Appl. No.: 12/118,900

(22) Filed: May 12, 2008

(51) Int. Cl. A23G 3/48

(52) U.S. Cl. 426/542

(57) ABSTRACT

A dry edible sugar-based sweetener composition in the form of a granular or powdered material containing a first quantity of at least one natural sugar combined with a second quantity of polyphenolic antioxidants (aka phenolic antioxidants, measured as gallic acid equivalents). The phenolic antioxidants are provided by at least one dry water-soluble extract purified from edible fruit and/or vegetable material, in which the ratio of the second quantity to the first quantity is preferably between 0.5% and 10% by weight.

### RELATED APPLICATIONS

Not Applicable.

### FIELD OF THE INVENTION

The present invention relates to polyphenolic antioxidant-supplemented sugars in which a nutritionally balancing level of polyphenolics helps prevent oxidative damage to the human body from high glycemic index sugars.

### BACKGROUND OF THE INVENTION

The following discussion is provided solely to assist the understanding of the reader, and does not constitute an admission that any of the information discussed or references cited constitute prior art to the present invention.

### Nutritive Sugars

Certain information in this section has been extracted from an article published in the FDA Consumer magazine in 1992 entitled “Not Only Sugar is Sweet” by Alexandra Greeley. (see http://www.fda.gov/bbs/topics/CONSUMER/CON00133.html)

Table sugar, i.e., sucrose, and other natural carbohydrate-based granular and powdered sweeteners such as fructose are very popular food commodities given that most humans prefer sweet tastes over acid, salt, bitter and sour tastes. Natural sugars contribute a wide variety of valuable properties to foods besides their sweetening ability, including adding bulk to baked goods, helping foods brown, and promoting natural fermentation. However, sugars have also generated a variety of health concerns.

Sucrose, which is typically refined from sugar beets and sugar cane, is a disaccharide composed of the two monosaccharide sugars, glucose and fructose. It is subsequently converted and sold in granular or powdered form, or may be compressed into solid sugar cubes. When mixed with small amounts of molasses that contributes color and flavor, brown sugar is obtained. Other edible disaccharide sugars include lactose (glucose and galactose) and maltose (two glucose molecules).

The Food and Drug Administration defines sugars as containing from one to four monosaccharide units, as well as sugar alcohol derivatives (also known as polyols) such as sorbitol, for example. Sorbitol (about 60 percent as sweet as sucrose) provides about the same number of calories per gram as sucrose but is a low glycemic index sweetener, and therefore only minimally stimulates insulin production. Sorbitol is used in a variety of products including candies and chewing gums. Some of the other low glycemic index polyols that have applications as food ingredients include erythritol, glycerin, hydrogenated starch hydrolysates (HSH), isomalt, lactitol, maltitol, mannitol and xylitol. Digestion of more complex carbohydrates converts most carbohydrates to glucose that is absorbed into the bloodstream where the liver stores it as glycogen if it is not required for immediate energy.

Currently, the following nutritive sugars are considered GRAS (generally recognized as safe) by the U.S. FDA, and may be routinely used in foods: (a) the monosaccharides—glucose (dextrose) and fructose (levulose), (b) the disaccharides—sucrose (aka cane sugar/beet sugar/table sugar consisting of glucose+fructose), maltose (malt sugar or di-glucose) and lactose (milk sugar consisting of glucose+galactose), and (c) the sugar alcohol—sorbitol.

Sucrose and fructose are produced by most green plants during photosynthesis and are present in both fresh and processed fruit and vegetable-containing foods. While many people may believe there is a difference between sugar naturally present in fresh fruit, and a refined sugar in a packet of granular sugar, the sugar is metabolized in the body using the same enzymatic and biochemical pathways. However, there are other nutritional and physiological factors that can influence the response of the human body to sugar intake depending upon whether the sugar is metabolized rapidly or slowly and depending upon the presence of other nutrients and micronutrients that may be co-metabolized with the sugar.

Data from the U.S. Department of Agriculture suggest that the per capita dietary intake of sugar including principally refined sucrose and fructose in foods and beverages (largely in the form of high fructose corn syrup) has increased dramatically (15-20%) in the U.S. during the past thirty years. Over a decade ago it was estimated by Paul Lachance at Rutgers University that the average American consumes about 300 calories per day from sugars added to food (about 14 teaspoons of table sugar). Unfortunately, the typical American diet contains about 45% carbohydrates, 20% protein, and 30-35% fat. Of the 45% carbohydrate, the natural and added sugars account for about 21% of the total daily caloric intake, of which approximately 11% of calories consumed are accounted for by sugar added to food. Jane Hurley (a nutritionist at the Center for Science in the Public Interest, Washington, D.C.) and others have cautioned that if people generally eat increasingly larger proportions of caloric (nutritive) sweeteners in soft drinks and other foods, these could compete and crowd out beneficial nutrients in the diet. Diverse fruits, for example, contain more of the important nutrients and micronutrients such as minerals, vitamins and antioxidants that are essential for human health.

While many scientists doubt that in a varied diet there is a direct cause and effect between eating refined sugar and many health problems (including obesity, heart disease, type 2 diabetes, some forms of cancer, anxiety, fatigue, depression and hyperactivity), other scientists believe there may be a linkage between excessive consumption of sugar and these conditions, particularly when processed sugary foods replace “healthy sweets” in the diet such as fruits and fruit juices. For example, carbonated soft drinks containing large amounts of high fructose corn syrup and lacking beneficial minerals and micronutrients are often consumed in place of more expensive fruit and vegetable juices.

### Non-Nutritive Sweeteners

Nonnutritive or synthetic sweeteners provide sweetness in foods and beverages without adding calories and typically without adding to the glycemic load that burdens the body's insulin system. Presently, there are several such sweeteners that have been approved by the FDA to replace sugar in a variety of food and over the counter items such as mouthwashes and toothpaste. These include:
(a) saccharin—about 300 times sweeter than table sugar.
(b) aspartame—about 200 times sweeter than table sugar. Individuals suffering from the genetic disease called phenylketonuria cannot tolerate the amino acid, phenylalanine, in aspartame. Aspartame is sold in packets and used in many foods such as cereals, beverages, and powdered iced tea. It is not stable during extended exposure to high heat so it is not used in cooking.
(c) sucralose—approximately 600 times sweeter than table sugar, twice as sweet as saccharin, and four times as sweet as aspartame. Unlike aspartame, the sucralose molecule (C₁₂H₁₉Cl₃O₈), also known as trichlorosucrose, is stable to heat and broadly varying pH conditions, and can be used in baking and in products that require a long shelf life. It is currently a patented product and is based upon chlorinated sucrose that is not digested.

### Single Serving Sweeteners in Packets

Single serving sweetener packets are commercially available, including sugar packets as well as reduced calorie and non-nutritive artificial sweetener packets. These packets consist of folded and heat-sealed paper and thermoplastic laminated packages containing a single serving of granular or powdered sweetener. The packets are typically small, measuring approximately 1.5×2.5 inches. Sugar packets are commonly supplied in restaurants and coffee shops in preference to loose sugar and sugar dispensers to save on employee labor and clean-up costs and to provide portion control. It is common for sugar to be packaged in white packets while the synthetic sweeteners are typically color-coded in the U.S. and elsewhere, with pink packets for saccharin (e.g., Sweet'N Low® brand), blue for aspartame (e.g., Equal® brand) and yellow for sucralose (e.g., Splenda® brand).

Depending upon the country and manufacturer, the definition of a “single serving” of sugar in a sugar packet may vary between approximately 4 grams in the U.S., and 10 grams in some foreign countries. Although a 4 gram sugar packet may contribute only 15 calories, many people prefer to add between two and four packets of sugar to a beverage, thereby contributing 50 or more calories to ones diet. It is not uncommon for people to consume up to four cups of coffee and/or tea per day, thereby adding 200 or more calories to their daily dietary calories. Single serving sugar packets are also used when sweetening pancakes, waffles, yogurt, fresh fruit desserts and many other foods. Some health-conscious people who have weight control problems and/or diabetes may opt for artificial sweetener packets containing aspartame, sucralose or saccharin. However, many people who suffer from the current epidemic of obesity and type 2 diabetes still consume large quantities of sugar, some or much of which may be consumed via multiple “single serving” sugar packets added to coffee, tea and hot chocolate beverages and/or a multiplicity of other foods and beverages ranging from breakfast cereal to waffles and yogurt.

### Polyphenolic Antioxidants in the Human Diet

Tea, coffee and diverse fruits provide a variety of polyphenolic antioxidants that are believed to protect a wide variety of cells, tissues and organs in the human body. For example, traditional Camellia sinensis-based teas (traditional hot water infusions of green tea, black, oolong and white teas) contain high levels of beneficial catechin-type antioxidants, e.g., epicatechin (EC), epicatechin gallate (ECG), epigallocatechin (EGC) and epigallocatechin gallate (EGCG), the most abundant catechin in tea. In addition to such teas, traditional coffees provide substantial amounts of phenolic antioxidants including catechin-type compounds and chlorogenic acid compounds. The catechins are well known flavonoids (flavan-3-ols), and make up as much as 10% of the dry weight of fresh tea leaves.

Fruits and vegetables are an even more prominent dietary source of antioxidants for people of all ages. Fruits including grapes, berries, pomegranates and many other species provide high levels of polyphenolic antioxidant compounds that are beneficial to ones health. In particular, the skin and seeds of many types of fruits and vegetables are rich sources of these antioxidants, including extracts prepared from the skins and seeds of grapes. Such phenolic-based compounds include, but are not limited to, the monomeric single ring phenolic compounds, e.g., benzoic and cinnamic acid derivatives such as gallic and coumaric acids, and the polyphenolic compounds such as the two ring stilbene derivatives, e.g., resveratrol, the three ring compounds including the flavonoid derivatives such as the flavanols, flavonols, and anthocyanidins.

Many health benefits have been attributed to the dietary consumption of one group of natural polyphenolic antioxidants known as the proanthocyanidins owing to the influence of these antioxidants on cellular physiological processes. A partial list of compromised health conditions that are reported to benefit from the proanthocyanidins, are as follows: heart disease and atherosclerosis, pancreatic inflammation, cancer cell proliferation, kidney, lung and heart cell damage (e.g., damage caused by chemotherapeutic drug treatments). Other polyphenolic antioxidants have been shown to beneficially modulate or control blood platelet aggregation, LDL oxidation, endothelial dysfunction, rheumatoid arthritis and leukemia cell propagation. A bibliography that encompasses much of the recent research (years 2000-2005) involving polyphenolic antioxidants and their role in controlling disease is provided in the book, Muscadine Medicine by Hartle, Greenspan and Hargrove (2005) ISBN Number 1-4116-4397-6. The antioxidants present in wines and purple grape juices have received a great deal of attention in recent years. Some examples of research involving grape antioxidants are as follows:

1) O'Byrne et al. Am J Clin Nutr (2002) 76(6):1367-1374 who compare two groups of healthy adults consuming either vitamin E (400 IU RRR-alpha-tocopherol) per day or 10 ml Concord grape juice (CGJ) per kg body weight per day for two weeks. Whereas the serum ORAC value (Oxygen Radical Absorbance Capacity) and the resistance of plasma LDL cholesterol to oxidation were increased to comparable extents by both treatments, CGJ was significantly more effective than vitamin E in protecting plasma proteins against oxidation.

2) Frankel et al. J Agric Food Chem (1998) 46:834-838 and Ghiselli et al. J Agric Food Chem (1998) 46:361-367 have shown that the anthocyanin polyphenolic antioxidants in Concord grape juice and red wine strongly retard LDL lipid peroxidation.

3) Freedman et al. Circulation (2001) 103(23):2792-2798 incubated blood platelets with dilute purple grape juice (PGJ). This led to beneficial inhibition of platelet aggregation, enhanced platelet-derived nitric oxide release and decreased oxidative activity (superoxide production). This was confirmed in vivo with healthy human subjects consuming 7 ml PGJ per kg body weight per day for 2 weeks, as platelet aggregation was inhibited, platelet-derived nitric oxide production nearly doubled, superoxide production decreased by about ⅓, plasma vitamin E levels increased and plasma antioxidant status improved.

4) Osman et al. J Nutr. (1998) 128(12):2307-2312 describes the role of platelet aggregation in contributing to atherosclerosis and acute thrombosis formation. Gastric administration of 5-10 ml purple grape juice per kg body weight was capable of reducing platelet aggregation in both dogs and monkeys, whereas neither orange juice nor grapefruit juice showed such activity. The authors concluded that grape juice is very effective because it contains high levels of the flavonoids—quercetin, kaempferol and myricetin that are known to be effective inhibitors of platelet aggregation in vitro, whereas the citrus juices contain other flavonoids that are poor inhibitors of platelet aggregation.

5) Ko et al. J Med Food (2005) 8(1):41-46 evaluated the antioxidant status in human plasma for up to 2 hours following consumption of 150 ml of nine different fruit juices by healthy adult males, using the method of measuring dichlorofluorescein fluorescence whose intensity indicates the level of reactive oxygen species in the plasma. Grape juice was the only juice to exert a persistent antioxidant activity that depressed the fluorescent intensity for over two hours following ingestion.

6) Ariga Biofactors (2004) 21(1-4):197-201 describes the proanthocyanidin antioxidants found in grape seed extracts. These compounds were found to be substantially more active than either vitamin C or vitamin E in aqueous systems, and were shown to slow the progression of a number of diseases in animal models. In a separately published USDA database (www.nal.usda.gov/fnic/foodcomp/Data/PA/PA.html), it has been reported that among a large number of juices and beverages tested, Concord purple grape juice contained the highest concentration of the proanthocyanidins (124 mg per 8 oz serving). This same database reported that raw grape seeds contain between approximately 400 mg and 1 g proanthocyanidins per 100 g of raw seeds. Applicant has determined that grape seeds contain approximately 10% by weight phenolic antioxidants so that it is estimated up to approximately 10% of the phenolics in grape seeds may be proanthocyanidins.

7) Shi et al. J Med Food (2003) 6(4):291-299 describe grape seed waste from production of grape juice in which the seed contains 5-8% polyphenols, mainly flavonoids, including gallic acid, the monomer flavanols catechin, epicatechin, gallocatechin, epigallocatechin, epicatechin 3-O-gallate, and procyanidin dimers, trimers and higher polymers. The antioxidant power of grape seed polyphenolic proanthocyanidins is claimed to be 20 times greater than vitamin E and 50 times greater than vitamin C.

### Combinations of Antioxidants and Sweeteners

Some combinations of antioxidants and sweeteners have been described. In most cases, antioxidant preparations are described in which a small amount of sweetener may be added, e.g., to improve palatability. In addition, Prakash et al., U.S. Pat. Appl. Publ. 2007/0116838, published May 24, 2007 concerns functional sweetener composions that include “high-potency sweetener, at least one sweet taste improving composition, and at least one functional ingredient, such as antioxidants.” It further indicates that the invention concerns “functional sweetener compositions and methods that can improved the tastes of non-caloric or low-caloric high-potency sweeteners.”

Badalov, U.S. Pat. Appl. Publ. 2008/0014331 describes a “method for making novel health benefiting super sweet sugar crystals and super sweet sugar syrups and super sweet molasses.” The method includes multiple steps, including a step of “mixing the saturated sugar liquor with at least one high intensity sweetener” and further involves boiling the mixture of saturated sugar juice and high intensity sweetener under vacuum until crystals begin to form. The method can also include mixing the super saturated sugar liquor or super sweet crystallized sugars with therapeutically effective and regulatory safe dosages of at least one of an extensive list of ingredients including, inter alia, bromelain, chitosan, salicin, inosin, myoglobin, glucomannan, guaranine, pectin, pantothenic acid, spiruline, caffeine, therobromine, theophylline, cocoa powder, coffee, lecinthin, choline, inositol, QABA, DHEA, any of a number of different amino acids, enzymes such as superoxide dismutase and papain, and antioxidants such as alpha-lipoic acid, bilberry, coenzyme Q10, glutathione, grape seed extract, green tea, selenium, zonc, boron, calcium, chromium, copper, iron, magnesioum, potassium, and aspartame.

### SUMMARY OF THE INVENTION

The present invention concerns mixtures of pro-oxidant sugars with complex mixtures of polyphenolic antioxidants. It has been found that sugars most commonly used for dietary sweeteners, especially sucrose and fructose, are pro-oxidants which have undesirable physiological effects when ingested in substantial quantities. It has also been recognized that many fruits likewise contain substantial quanties of such sugars, but do not appear to produce such undesirable physiological effects. Quite to the contary, such fruits are recognized as healthful dietary components. It appears that the pro-oxidant effects of the sugars are counterbalanced by the presence of complex mixtures of polyphenolic antioxidant compounds in such fruits. Thus, the present mixtures approximate the types of combinations of sugars and polyphenolic antioxidants found in antioxidant rich fruits, thereby countering the contributions of the sugar to oxidative stress.

Thus, a first aspect of the invention concerns a dry, edible, balanced pro-oxidant sugar and polyphenolic antioxidant mixture. The mixture includes a first quantity of at least one granular or powdered sugar which includes sucrose or fructose or both and at least one dry water-soluble extract purified from edible plant material. The extract contains a second quantity of complex polyphenolic antioxidants, where the ratio of the second quantity to the first quantity is within the range of ratios of complex polyphenolic antioxidants to sugars in antioxidant-rich edible plant materials.

In particular embodiments, the ratio of polyphenolic antioxidants to sugar is from 0.25% to 15.0%, 0.5% to 10%, 1% to 5%, 5% to 10%, or 2% to 7% by weight; the extract is derived from fruit or from Camellia sinensis leaves or both; at least 30, 40, 50, or 60% by weight of the polyphenolic antioxidants consist of monomeric and polymeric proanthocyanidin molecules; the extract contains at least 30, 40, 50, 60, 70, 80, or 90% by weight polyphenolic antioxidants.

Also in certain embodiments, the pro-oxidant sugar and polyphenolic antioxidant mixture is pre-measured and packaged in single serving packages containing from 3 g to 10 g per package.

A related aspect of the invention concerns a dry, edible, balanced pro-oxidant sugar and polyphenolic antioxidant mixture that contains a first quantity of at least one sugar, a second quantity of polyphenolic antioxidants provided by at least one dry water-soluble extract purified from edible plant material, and optionally no more than 5% by weight of a sugar substitute sweetener. The ratio of the second quantity to the first quantity is from 0.25% to 15% by weight.

In particular embodiments, the ratio is from 0.5% to 10%, 0.5% to 5%, 0.5% to 2%, 0.5% to 1%, 1% to 5%, 1% to 2%, 2% to 5%, 2% to 7%, or 5% to 10% by weight; the extract contains at least 30, 40, 50, 60, 70, 80, or 90% by weight polyphenolic antioxidants; at least 30, 40, 50, or 60% by weight of the polyphenolic antioxidants are monomeric and polymeric proanthocyanidin molecules.

Also in particular embodiments, the extract is substantially caffeine-free; the extract is purified from fruits (e.g., berries such as blueberries, raspberries, strawberries, blackberries, and/or cranberries, plums, cherries, apples, or grapes), vegetables, beans, Camellia sinensis leaves or any combination of two or more of these sources; the extract is prepared from fruits or vegetables or both selected from the group consisting of fruit berries, fruit pomace, fruit seeds, fruit skins, Camellia sinensis leaves, and combinations thereof; the extract is prepared from grape pomace or components thereof, e.g., grape skins and grape seeds; the extract is prepared from grape seeds and provides monomeric and polymeric proanthocyanidin phenolic antioxidants (e.g., at levels as specified above); the extract is prepared from Camellia sinensis leaves and provides epicatechin (EC), epigallocatechin (EGC), epicatechin-3-gallate (ECG), and epigallocatechin-3-gallate (EGCG) phenolic antioxidants (e.g., at levels of at least 20, 30, 40, 50, 60, or 70% by weight of the polyphenolic antioxidants present in the extract).

In certain embodiments, the mixture is provided in single serving form (e.g., formed in solid blocks such as cubes or packages in packages such as packets or sleeves) containing from 3 to 10, 4 to 7, or 5 to 10 grams per single serving; in single serving forms (e.g., packages) of the mixture the extract provides at least 20, 25, 30, 40, 50, 60, 70, 80, 90, 20-40, 40-60, 60-100 mg of the polyphenolic antioxidants per single serving.

In particular embodiments, the sugar includes sucrose or fructose or both; the mixture also includes at least one non-sweetener flavoring agent; the mixture includes a sugar substitute, e.g., sucralose, saccharin, aspartame, or a combination thereof.

Another related aspect of the invention concerns a method for reducing the oxidizing effects of a pro-oxidant sugar, and involves forming a mixture consisting essentially of a first quantity of a sugar-based sweetener and an extract from edible plants, where the extract contains a second quantity of polyphenolic antioxidants and where the ratio of the second quantity to the first quantity is from 0.25% to 15% by weight.

In certain embodiments, the method also includes a person ingesting the mixture, e.g., added to a beverage such as coffee or added to a food recipe.

Likewise, in certain embodiments, the sugar-based sweetener consists essentially of sucrose, fructose, or both.

In particular embodiments, the mixture is as specified for one of the preceding aspects or otherwise described herein for the present invention.

Additional embodiments will be apparent from the Detailed Description and from the claims.

### DETAILED DESCRIPTION OF THE PREFERRED EMBODIMENTS

This invention concerns a sugar composition that is formulated to be more healthful, and more specifically, a blended granular or powder natural sweetener such as table sugar, that is supplemented with at least one natural complex polyphenolic antioxidant extract obtained from fruit and/or vegetable material. The antioxidant extract can be provided in the form of a water-soluble composition, e.g., a powder, that contains a diversity of polyphenolic antioxidant molecular species. The antioxidant is combined with a sugar-based sweetener to produce a free-flowing dry granular or powder blend that can advantageously be provided in single serving form, e.g., packaged in single serving packets or formed into solid blocks. These packets typically contain an amount of sweetener corresponding to the sweetening capacity of between 3 and 10 g of table sugar. The consumption of such sweetener in popular beverages and foods including coffee, tea, yogurt, breakfast cereal and the like, will provide individuals with the type of balance between sugars and polyphenolic antioxidants found in edible plant matter (e.g., fruits), and therefore will counteract the pro-oxidant effects of the sugars while avoiding the deleterious effects reported for ingestion of high levels of single antioxidants.

Underlying the present invention is the concept that naturally occurring polyphenolic antioxidants (herein abbreviated “PA”) can be provided in an amount to be combined with a sugar-based sweetener (abbreviated “S”), where the amount of PA is sufficient to compensate for the in vivo pro-oxidative effect of metabolizing high glycemic index sweeteners. Applicant has found that sufficiently concentrated sources of dried PA extract are available so that the amount of PA that needs to be added to a sweetener need not unacceptably or significantly increase the bulk volume of sweetener contained within a conventional single serving packet. Further contributing to the concept of the invention, highly preferably the ratio by weight of PA to S to be combined in single serving sweetener packets (or alternatively in bulk sweeteners) should either approximate or be greater than the PA/S weight ratio calculated for healthful antioxidant-rich fresh fruits.

In contrast to the present invention, previously combinations have been made in which sugars and other sweeteners were used in comparatively small amounts to help to improve the flavor or palatability of compositions that contain large amounts of phenolic compounds or other antioxidants that tend to be astringent or bitter. Some compositions have also been described in which high intensity sweeteners (generally artificial sweeteners) were combined with antioxidants. In contra-distinction to such compositions, the present balanced combinations are designed such that pro-oxidant sugars (such as sucrose) are balanced with a complex polyphenolic antioxidant mixture to approximate the ratios of polyphenolic antioxidant to sugar provided by healthful fruits.

Thus, by the use of a limited amount of antioxidant in the present invention, the PA/S ratios measured for antioxidant-rich fresh grapes and berries such as fresh Thompson and Flame table grapes, blueberries, raspberries and the like can be used as reference numbers, and can be approximately matched in the presently invented sugar-based sweetener blends. This can be accomplished using a combination of sweetener and polyphenolic antioxidant extract prepared from natural fruit and/or vegetable materials. Thus, for example, 80 mg of powdered grape seed antioxidant extract containing ≧95% by weight PA can be combined with a 4 g quantity of sucrose to provide a PA/S ratio of 2% (w/w) that typically exceeds the PA/S weight ratio measured in grapes. This is described in greater detail below. As a broader example, mixture can be provided by combining the components in proportions of 4 g sugar (e.g., sucrose and/or fructose) with 20-200 mg of the PA grape seed extract (e.g., Activin® extract, see below). The mixture can be packaged in single serving packages, e.g., heat-seal-packaged in single serving sweetener packets. In this example, the resulting PA/S ratio would range between approximately 0.5% and 5% by weight, preferably approximately 1%-2%. Alternatively, sugar alcohols (polyols) such as sorbitol may be included with the natural sugar.

In many cases, the present combinations contain only natural sugars as the sweetener components. However, in some cases it may be desirable to include a limited amount of a high intensity sweetener, e.g., aspartame or sucralose, along with the natural sugar. In this way, a reduced calorie sweetener may be provided that substantially retains the taste of natural sugar. In such cases, the natural sugar is usually sucrose, fructose, or a combination of sucrose and fructose. The latter is a sugar combination commonly found in berries.

The discussion below further explains some of the rationale and benefits of the present invention.

### Increased Occurrence of Diabetes in the U.S.

The significance of the present invention is emphasized by the prevalence of diabetes (especially Type 2 diabetes) and the impact of dietary consumption of sugars on the development and course of diabetes, and on individual health in general.

The three main types of diabetes are types 1 and 2, and gestational diabetes. Type 1 diabetes which is responsible for 5-10% of diagnosed diabetes cases is an autoimmune disease, in which the body's immune system, perhaps triggered by a virus, genetic or environmental factors attacks and largely destroys the insulin-producing beta cells in the pancreas. The pancreas then produces little or no insulin, and a person with type 1 diabetes must take insulin daily.

On the other hand, gestational diabetes occurs in about 3 to 8 percent of pregnant women typically late in the pregnancy. Although this form of diabetes usually disappears in the mother following the baby's birth, women who develop gestational diabetes can have between a 20 and 50 percent chance of developing type 2 diabetes within 10 years following pregnancy. Maintaining a healthy body weight and being physically active may help prevent development of type 2 diabetes.

By contrast, about 90 to 95 percent of diagnosed cases of diabetes are type 2 diabetes (abbreviated TTD). This form of diabetes is commonly associated with obesity (about 80% of patients are overweight), family history of diabetes, physical inactivity, and certain ethnicities. Unfortunately, TTD is being increasingly diagnosed in children and adolescents. With TTD, the pancreas usually produces sufficient insulin, but the body does not use the insulin effectively. This physiological condition is known as insulin resistance. After several years, insulin production tends to decrease, and as with type 1 diabetes, glucose accumulates in the blood causing a variety of problems as the body does not efficiently metabolize glucose. TTD symptoms may develop gradually, including fatigue, increased thirst, more frequent urination, hunger, weight loss, vision problems, and slow healing of wounds.

### Link Between Sugar Consumption, Obesity, Insulin Resistance and Cardiovascular Problems

Some observations in this section reflect and summarize an article by Fred Pescatore, M.D. found on the worldwide web at http://www.defeatdiabetes.org/Articles/cvd030212.htm. Pescatore links the increase in sugar consumption over the past 50 years with cardiovascular health problems, i.e., a diet high in sugar will cause more morbidity and mortality from heart disease. He cites the Iowa Women's Health Study and the Nurses Health Study showing that women with high glycemic load diets had up to 2-fold greater risk of cardiac heart disease. In the Nurses Health Study, the analysis was controlled for total energy intake and other dietary and non-dietary risk factors, the difference being the source of nutrient calories in the diet. With high glycemic load diets, the ingestion of many foods such as starches and sweets that have an intrinsically high glycemic index (rapidly metabolized by the body) cause large swings in blood glucose levels. Foods that contain high levels of sugars and starches (e.g., rice, potatoes, white bread) contribute largely to glycemic load. With white bread given a glycemic index of 100, foods metabolized more slowly are given a number lower, while foods metabolized more quickly are assigned a higher number. Macronutrient content of an entire meal is evaluated in determining the glycemic load.

Pescatore states that postprandial hyperglycemia is an independent and significant risk factor for cardiovascular disease as well as diabetics because spiking glycemic levels have been correlated with arterial wall thickening. He points out that hyperglycemia contributes to oxidative stress on the body, contributing also to cardiovascular disease risk. That is, large repeated swings in blood glucose levels contribute to oxidation of membrane lipids, proteins, lipoproteins, as well as causing systemic inflammation. Pescatore also points out a correlation between the decrease in the level of antioxidants in the blood with increased blood pressure, accelerated clot formation, and reduced blood flow—all factors that can lead to stroke.

With regard to insulin levels, a high glycemic index diet with high levels of sugar or starch may also affect the risk for cardiovascular disease by increasing insulin levels in the body as much as 2-fold over a lower glycemic index diet. Such “hyper-insulinemia” is believed to cause, at least in part, the insulin resistance syndrome and increased risk of heart disease, with effects on blood pressure, serum lipids, coagulation factors, inflammatory mediators, endothelial function, and ability of glucose to enter cells.

Dietary sugar and starch also negatively affects plasma cholesterol lipoproteins, with an inverse relation between dietary sucrose and cardioprotective “good” cholesterol, i.e., HDL cholesterol. Still other studies show that a diet high in sugar (greater than 20% of caloric intake) is harmful because it is associated with an elevation of plasma triglyceride concentrations (from increased hepatic secretion and decreased clearance of VLDL), where higher triglyceride levels can lead to atherosclerotic plaque formation and pancreatitis, particularly in diabetics.

In other words, ingesting a diet lower in sugar and simple carbohydrates provides the benefits of higher HDL levels, lower triglyceride levels and lower heart attack rates compared to high glycemic load diets.

Oxidative Damage with Insulin Resistance in Type 2 Diabetes

Johansen et al. published an article appearing in Cardiovasc Diabetol. 2005; 4:5 and also on the worldwide web at http://www.pubmedcentral.nih.gov/articlerender.fcgi?artid=1131912 entitled “Oxidative stress and the use of antioxidants in diabetes: Linking basic science to clinical practice.” The abstract of the article reads:

“Cardiovascular complications, characterized by endothelial dysfunction and accelerated atherosclerosis, are the leading cause of morbidity and mortality associated with diabetes. There is growing evidence that excess generation of highly reactive free radicals, largely due to hyperglycemia, causes oxidative stress, which further exacerbates the development and progression of diabetes and its complications. Overproduction and/or insufficient removal of these free radicals result in vascular dysfunction, damage to cellular proteins, membrane lipids and nucleic acids. Despite overwhelming evidence on the damaging consequences of oxidative stress and its role in experimental diabetes, large scale clinical trials with classic antioxidants failed to demonstrate any benefit for diabetic patients. As our understanding of the mechanisms of free radical generation evolves, it is becoming clear that rather than merely scavenging reactive radicals, a more comprehensive approach aimed at preventing the generation of these reactive species as well as scavenging may prove more beneficial. Therefore, new strategies with classic as well as new antioxidants should be implemented in the treatment of diabetes.”

Kaneto et al. in a study published in the research journal Diabetes 48:2398-2406 (1999) demonstrate that in a mammalian model study using diabetic mice, treatment with the antioxidant, N-acetyl-L-cysteine (NAC), enabled the animals to maintain healthy glucose-stimulated insulin secretion and controlled blood glucose levels, unlike the untreated animals or animals receiving the classic antioxidant vitamins C and E. Insulin mRNA levels were also maintained at higher levels in the NAC-treated animals. Histologic examination of the pancreas β-cells from NAC-treated animals showed that these cells were more abundant, i.e., protected, and able to continue proliferating. It is hypothesized that in chronic hyperglycemia, oxidative stress causes accelerated death of β-cells that can be suppressed by antioxidant treatment.

These conclusions are further supported by studies such as Busserolles et al., 2002, British Journal of Nutrition, 87:337-342 which discusses the effects of the consumption of a high sucrose diet by rats. The article observed that consumption of a high-sucrose diet negatively affects the balance of free radical production and antioxidant defence, leading to increased lipid susceptibility to peroxidation. It further noted that the study results suggest that sucrose feeding can cause severe cell injury to pancreatic β-cells. Oxidative stress resulting from high fructose (e.g., as contained in sucrose) consumption was also related to other detrimental effects.

### Benefits of Dietary Inclusion of Balanced Sugars and Antioxidants

In view of the detrimental effects of high sucrose or fructose ingestion, Applicant herein describes a health paradox that appears to exist with regard to sugar consumption and TTD. On the one hand, consuming sugar in candy bars and high fructose corn syrup-sweetened beverages is unhealthful, and is believed to be a contributing factor in the epidemic of obesity and type 2 diabetes that has appeared in recent years. On the other hand, humans have thrived for thousands of years eating a natural diet rich in vegetables and fruits that also contain substantial levels of sugar. For example, substantial dietary intake of berries is considered healthful in spite of the sugar (sucrose and fructose) contained in these fruits. This suggests that the substantial amount and diversity of polyphenolic antioxidants contained in such berries and other fruits is essential for compensating the pro-oxidant effect of high glycemic index sugars including sucrose and fructose. Applicant believes that without those polyphenolic antioxidants, fruits and berries would contribute to, rather than help prevent, health problems. This would suggest that specific polyphenolic antioxidant molecular species or combinations of such molecular species, many of which have not as yet been thoroughly investigated, play an important role in preventing as well as treating damage to insulin-secreting β-cells from an ongoing condition of TTD (type 2 diabetes).

Further to this point, as indicated above medical research has linked oxidative stress to insulin resistance, a physiological syndrome that elevates blood glucose levels and greatly increases the risk of diabetes and cardiovascular complications. Antioxidants compounds can reduce oxidative stress, and thereby reduce the health risks associated with diabetes including TTD in which most patients exhibit insulin resistance. A diversity of antioxidants in the human diet such as the very diverse polyphenolic antioxidants contained in fresh fruit and their extracts, e.g., strawberries, raspberries, grapes and extracts from viniferous grape seeds and skins, have been shown to provide significantly greater protection in vivo against oxidative stress than high levels of the simple antioxidant vitamins, i.e., vitamins E, C and A.

Indeed, a large meta-analysis of studies involving administration of several different synthetic antioxidants, including vitamin A, beta carotene, vitamin E, and vitamin C, revealed either an increased mortality from all causes, or no significant effect on mortality. The report specifically noted that the “findings should not be translated to potential effects of fruits and vegetables. Bjelakovic et al., 2007, Mortality in Randomized Trials of Antioxidant Supplements for Primary and Secondary Prevention: Systematic Review and Meta-analysis, JAMA 297:42-857.

The view that a proper balance of mixtures of polyphenolic antioxidants with sugar can counter the contribution of the sugar to oxidative stress is also consistent with evolution and Darwinian selection in which humans and their metabolic capabilities evolved over the millennia to allow survival in a biosphere that included fruits and vegetables as an important source of nutrients. It is reasonable to infer that over the millennia the PA/S weight ratio in such fruits and vegetables has been sufficient for the antioxidants in fruits and vegetables to substantially protect the body from pro-oxidant effects of the sugars in the fruits and other naturally produced dietary components.

To determine this PA/S ratio in nature, Applicant found literature and online reference material with relevant information, e.g., Phenolics in Food and Neutraceuticals by Shahidi and Naczk, chapter 4) and http://www.fruit.cornell.edu/Berries/bramblehtml/rasprelfru.html and http://www.nutritiondata.com/. Applicant selected berry and grape species, i.e., blueberries, raspberries and table grapes that contain among the highest levels of the polyphenolic antioxidants. It has been determined from the Cornell reference that ripe raspberries contain 5-6% by weight sugar and as much as 0.14% by weight polyphenolics (measured in the juice therefrom). Therefore, the approximate ratio PA/S ratio for raspberries=0.14+5.5=2.5%.

For comparison, based upon the Shahidi et al. and the online reference, www.nutritiondata.com, ripe blueberries contain approximately 9.9% by weight sugar and between 0.19% by weight polyphenolics (average for 100 varieties of highbush blueberries) and 0.38% by weight polyphenolics (average for 155 varieties of lowbush blueberries). For a 100 g serving of highbush blueberries containing approximately 0.19% by weight polyphenolics, the individual can expect to ingest approximately 190 mg of polyphenolic antioxidants and approximately 10 g of sugar (for a PA/S weight ratio of approximately 2%).

By comparison, ripe table grapes such as the Thompson or Flame varieties, contain approximately 15-16% sugar, and provide approximately 0.20% by weight polyphenolics. Therefore, the PA/S weight ratio for grapes is approximately 1.3%. It is interesting to note that the sugar levels in commonly eaten fresh ripe fruit vary only approximately two-fold, i.e., from approximately 6-7% for watermelon, grapefruit and some berries, up to 15-16% by weight for grapes and mangos (see, e.g., www.nutritiondata.com), whereas polyphenolic antioxidant levels in the raw fruit vary over twenty-fold, i.e., from approximately 0.01 % by weight for melons to greater than 0.25% for some berries (see “Daily Polyphenol Intake in France from Fruit and Vegetables” in J. Nutr. 136: 2368-2373, 2006).

To achieve the higher and more healthful PA/S ratios found in the above berries and grapes in a single serving packet of table sugar as proposed in the present invention, Applicant supplements table sugar or other sugar-based sweeteners to preferably achieve a PA/S ratio similar to those founds in the high polyphenolic antioxidant content fruits, e.g, preferably at least 1% by weight of polyphenolic antioxidants, and preferably 2% by weight or higher, but not exceeding about 15%. For a 4 g packet of sugar, at least 40 mg and preferably 80 mg or more of polyphenolics (based upon gallic acid equivalents) can be added. It is convenient and feasible to add a highly concentrated antioxidant extract powder such as that purified from grape seeds, e.g., containing as much as 90% or more by weight of PA.

Thus, using this proportional approach to selecting the antioxidant level, considering a 100 g serving of table grapes that contains 16 g of sugar and 200 mg of polyphenolics, it would be reasonable for a 4 g single serving packet of sugar (containing only ¼ as much sugar) to provide approximately 50 mg of polyphenolics to approximately match the natural PA/S ratio in grapes. Over the course of a day if one consumes 4 packets of sweetener, the amount of polyphenolic antioxidants would be comparable to the 200 mg provided in a serving of grapes.

The PA-sugar blend can advantageously be packaged in single serving quantities such as in paper-thermoplastic laminated packets such as those commonly used in the U.S. measuring approximately 1.4 in.×2.5 in. or 2.0 in.×2.5 in. for example, and holding between 1 and 10 grams of blended sweetener powder.

With regard to preparing the PA extract for combining with sugar, a variety of methods have been described for preparing concentrated proanthocyandidin-containing extracts from the skins and seeds of grapes. Organic solvents including primary alcohols acetone and acetates have been cited in the literature as being highly effective polyphenolic extraction solvents. However, when possible, it is highly desirable to use water rather than organic solvents for the antioxidant extraction process. In U.S. Pat. No. 6,544,581 Shrikhande et al. describe a hot water process that includes extracting whole grape seeds with hot water at 140-212° F. for about 1-6 hours, and subjecting the extract to a dual pH treatment before using a series of additional treatments to purify and concentrate the antioxidant extract.

One preferred source of PA extract utilized in the present invention is a spray-dried preparation of dried water-soluble grape seed extract. For example, Activin® extract (produced by San Joaquin Valley Concentrates, Fresno, Calif.) has been produced from grape seeds for a number of years. A process for producing the extract is described by Shrikhande et al. in U.S. Pat. No. 6,544,581. This PA extract is produced in the form of microparticles that typically measure approximately 20-50 microns in diameter. Activin® typically contains over 90% by weight polyphenolics measured as gallic acid equivalent units. This purified powder extract, when dissolved in either cold or hot water, provides a clear, albeit slightly brown-tinted solution, and provide a means of fortifying ready-to-drink beverages. The smooth spherical powder particles (viewed at 600× magnification under phase-contrast microscopy) mix well with other powders but may also tend to settle and/or separate somewhat from other powdered materials. For example, Applicant has blended Activin® powder with fine and ultrafine granulated table sugar and sugar alcohol powders including sorbitol and mannitol, and in each case, the Activin® powder tends to somewhat separate from the sugars.

Supplementing Sugar With Proanthocyanidin Polyphenolic Antioxidants from Grape Seeds

Analysis of the phenolic antioxidant compounds in Activin® grape seed extract provided by San Joaquin Valley Concentrates shows that proanthocyanidin polyphenolic antioxidants (herein abbreviated pro-PAs) make up the bulk of the extract material. On a weight percentage basis, the pro-PAs in the extract include a total of approximately 70% hetero- and homo-polymers and monomers of catechin and epicatechin (abbreviated C and EC). More specifically, an analysis indicates approximately 11% monomers, 21% dimers, 20% trimers, 10% tetramers, 5% pentamers and 3% hexamers. The pro-PAs also include approximately 15% by weight epicatechin-3-gallate-containing polymers (abbreviated ECG) and approximately 10% by weight epigallocatechin-3-gallate-containing polymers (abbreviated EGCG). These compounds form the basis of dietary supplementation with grape seed extract. A number of independent lines of research evidence suggest that the ProPA compounds are metabolized by colonic microflora to very similar, if not the same, bioactive compounds produced from the metabolism of monomeric catechin compounds in green teas.

Indeed, the substantial equivalence of active metabolites from the grape seed antioxidants and the green tea antioxidant metabilites means that the beneficial effects of the green tea antioxidants can be provided by the use of grape seed derived antioxidants, e.g., provided in the form of grape seed antioxidant extract. As a result, when the grape seed antioxidant extract is used in a mixture with another edible material which lacks appreciable polyphenolic antioxidants, a combination is obtained that provides antioxidant benefits similar to green tea, but without the caffeine normally contained in green tea. This approach can, for example, but used to advantage with herbal teas. Most herbal teas lack appreciable antioxidants and particularly polyphenolic antioxidants, exceptions being mint leaf and berry leaves (e.g., raspberry) which contain antioxidants of types different from the catechin-type antioxidants provided by green tea. Individuals who like the flavor of a particular herbal tea and/or who wish to avoid caffeine can still obtain the antioxidant benefits with herbal tea supplemented with grape seed antioxidant extract or other source of similar Pro-PAs.

Likewise, decaffeinated tea extracts are also available (e.g., dry extracts, often in powdered form) and can be used to provide substantially caffeine-free catechin-type antioxidants, either alone or in combination with grape seed extract as indicated above. Thus, the grape seed extracts and/or decaffeinated tea extracts can be used to supplement herbal teas or other edible products to provide essentially the functional antioxicant effects of non-decaffeinated tea extracts.

Supplementing Sugar With Catechin Polyphenolic Antioxidants from Tea

A green tea catechin extract is defined as follows by National Cancer Institute at <http://www.cancer.gov/Templates/druqdictionary.aspx?CdrID=506041>. It contains polyphenolic flavonol catechins, isolated from the plant Camellia sinensis with antiviral, antioxidant, and potential chemopreventive activities. The primary catechins found in green tea are epicatechin (EC), epigallocatechin (EGC), epicatechin-3-gallate (ECG), and epigallocatechin-3-gallate (EGCG), the most potent. As potential chemopreventive agents, catechins scavenge free radicals, inhibit enzymes involved in cell replication and DNA synthesis, interfere with cell-to-cell contact adhesion, and inhibit various intracellular communication pathways required for cell division. In addition, it has been postulated that EGCG may “trap” growth factors such platelet-derived growth factor on cell membranes, immobilizing growth factors on cell membranes and preventing ligand-receptor crosslinking and growth factor receptor activation.

Significantly, a research study by Deprez et al. in J. Nutr. 130: 2733-2738(2000) entitled “Polymeric Proanthocyanidins Are Catabolized by Human Colonic Microflora into Low-Molecular-Weight Phenolic Acids” demonstrated that aromatic phenolic acids identified as metabolites of ProPA polymers, were similar to the metabolites produced by colonic microflora metabolism of either catechin or procyanidin dimer B3. In this study, ProPA polymers that were previously considered to be inert and unmetabolized in the digestive tract were shown to be just as easily degraded as other flavonoid monomers. Thus, it is likely that following passage through the human digestive system, grape seed extract can largely substitute for the catechin biofunctionalities found in regular Camellia sinensis teas (e.g., green, black, oolong and white teas). This substitution would occur without introducing any undesirable caffeine from the Camellia leaves. To Applicant's knowledge, this concept has not been appreciated in the prior art food and beverage literature.

In terms of health benefits, there have been reports over the past several years that ProPAs and their metabolites can beneficially inhibit aromatase enzyme activity, inhibit the growth of cancer cells in cell culture, and prevent or attenuate a number of diseases in various animal models of disease, including atherosclerosis, cataract formation, and skin and breast cancer. It is anticipated that the health benefits of ProPAs will parallel those reported for the catechin family of antioxidants, given that ProPAs has now been shown to be similarly metabolized in vivo via the digestive system's microflora.

Phenolic Antioxidant Levels in Grape Seed Extracts

Measurements of phenolic antioxidant levels in a variety of grape seed extracts prepared by Applicant are described herein, and were carried out using the Folin-Ciocalteau colorimetric assay (abbreviated herein “F-C assay”) as follows: Five microliters of sample solutions (or 5 and 10 microliter samples of a standard 0.100% by weight gallic acid solution) were diluted into 0.50 ml of distilled water. Fifty microliters of F-C reagent (Sigma-Aldrich, St. Louis, Mo.) were then added and mixed, and finally 0.25 ml of 15% by weight sodium carbonate solution was added (between 2 and 7 minutes later) with mixing. The resulting samples were incubated 2 hr in the dark before reading the optical absorbance at 760 nm.

Several findings are disclosed herein that enable the preparation of grape seed extracts containing high levels of polyphenolic antioxidants. First, grape seeds from non-fermented cold-pressed grapes were found to contain much higher levels of phenolics than grape seeds from either crushed grapes that had been fermented (in winemaking) or crushed grapes that had been heated for juice extraction. Thus, extracts from such non-fermented cold-pressed grape seeds are particularly advantageous for use in the present invention. Second, grape seeds from differing varieties of grapes produced extracts that differed in their antioxidant potency. Therefore, batch-testing of grape seeds is worthwhile to allow selection of high potency extracts. For example, some cold-pressed grape seeds contained as much as 10% by weight phenolic antioxidants (based upon GAE percentage) while others contained only 5%.

Grape seed extract is thus a rich and relatively cost-effective source of healthful polyphenolic antioxidants, given the abundance of viniferous grapes used to produce wines on a worldwide basis. While red and purple grape skins also serve as a valuable source of phenolic antioxidants, the dark color of anthocyanins makes them less desirable for use in supplementing many foods and beverages. Therefore, in advantageous embodiments, at least 50, 60, 70, 80, or 90% of the phenolic antioxidants used in the sweetener compositions described herein are derived from grape seeds.

Likewise in advantageous embodiments, at least 50% by weight of the dry water-soluble extract that is combined with sweetener to provide the present compositions is phenolic antioxidant, and preferably at least 75%, and more preferably at least 90% by weight of the extract consists of phenolic antioxidants (measured as gallic acid equivalents).

The ratio by weight of polyphenolic antioxidant to sweetener in the presently invented sweetener compositions is at least from 0.25% to 15%, and preferably from 0.5% to 10%. In particular cases, the ratio is 0.5% to 1%, 1% to 2%, 2% to 5%, or 5% to 10% by weight.

As described above, the dry water-soluble phenolic extracts for the sweetener compositions described herein can be conveniently prepared from fruits and/or vegetables and/or other plant materials, e.g., selected from the group consisting of fruit berries (such as strawberries, blueberries, raspberries, cranberries, grapes), fruit pomace (fruit pulp, skins and seeds remaining after pressing fruit for juice), fruit seeds, fruit skins, Camellia sinensis (tea) leaves, and combinations thereof. Because grapes in particular contain high levels of phenolic antioxidants, dry water-soluble extracts are usefully prepared from grape pomace or components thereof. In particular, these extracts can be prepared from grape seeds.

In exemplary embodiments, suitable and appropriate amount of the phenolic extract can be combined (per single serving of the sweetener) to provide at least 25 mg of the phenolic antioxidants, e.g., 25 to 50, 25 to 100, 25 to 200, 25 to 500, 50 to 100, 50 to 200, 50 to 500, 100 to 200, 100 to 500, or 200 to 500 mg. Given that grape seed extracts that contain upward of 90-95% % by weight phenolic antioxidants are commercially available, a 25 mg loading of such extract in a 5 g serving of sweetener will provide 0.5% by weight phenolics. Similarly, 50 mg and 100 mg of such grape seed extract in a 5 g serving of sweetener will respectively provide nearly 1% and 2% by weight phenolic antioxidants.

Convenient heat-sealable, moisture-resistant single serving packaging for granular and powdered sweeteners is available in the form of cost-effective packets and sleeves that measure between approximately 1.5×2.5 inches and approximately 2×2.5 inches. Alternatively, single serving quantities of granular or powdered sweetener can be combined with phenolic antioxidants and compressed into antioxidant-containing blocks, e.g., “sugar cubes.”

As still another option, the present sweeteners, e.g., single serving sweeteners, supplemented with polyphenolic antioxidants can be further supplemented with at least one flavoring agent such as vanilla extract, coffee extract or citrus extract, for example.

Teas and Coffees. Regarding teas, although there are many differing traditions, arts and methods relating to steeping of teas and making tea infusions (where the amount of loose tea leaves per serving, the water temperature, and the steeping time can differ for different tea varieties, including white, green, oolong, black, pu-erh, flavored and blended teas), for the purposes of this invention the reference concentration of antioxidants for any single strength tea (e.g., for green tea, black tea and others) can be measured after the steeping of between 2.0 and 2.2 grams of any variety of dried Camellia sinensis leaves that have been equilibrated in 8 fluid ounces of hot water (water initially at 85° to about 100° C. at one atmosphere) for a period of time sufficient to remove most (75% or more) of the antioxidants from the leaves that are extractable into hot water.

Regarding coffee, for the purposes of the present invention, a reference single strength coffee beverage is prepared using two level tablespoons of ground roasted coffee beans (one standard coffee scoop) for each six ounces of brew water. The brew water is preferably heated to a temperature of about 90° C. to about 95° C. for extracting the coffee flavors and antioxidants.

Health Benefits. The general population benefits from regularly consuming more fruit and vegetables that are rich in polyphenolic antioxidants. It is clear that polyphenolic antioxidants are part of a healthy diet. This invention provides sugar-based sweeteners that are supplemented with polyphenolic antioxidants in ratios similar to those found in edible plant materials. Polyphenolic molecular and bio-functional diversity can be provided by using a variety of sources of polyphenolic antioxidants. Such diversity permits a variety of health conditions to be treated or prevented with regular dietary intake of foods and beverages to which a sweetener is added containing multiple polyphenolic antioxidants rather than a single antioxidant chemical or antioxidant vitamin such as vitamin C or E. That is, multiple species and classes of phenolic molecules can be added to a food or beverage.

An increase of 25%, 50%, and preferably 70% or even 100%; i.e., a doubling, in the polyphenolic antioxidant content in a food or beverage can be achieved for a minimal cost as described above by adding between 0.2 and 1 cent of antioxidant extract per serving.

Admixture of a polyphenolic antioxidant-supplemented sweetener as described in the present invention should increase the antioxidant level of a food or beverage by at least 25%, preferably 50%, and more preferably about 60%, 70%, 80%, 90%, 100%, or even more; i.e., doubled, over the endogenous level of polyphenolic antioxidant compounds present in the precursor food or beverage.

Polyphenol-rich extracts such as Activin® grape seed extract produced by San Joaquin Valley Concentrates, Inc. have been prepared from grape seeds alone. By excluding the grape skins, a substantially anthocyanin-free (and color-free) extract can be produced from grape seeds that can be used to fortify lightly colored, e.g., tea-colored, beverages. Polyphenolic extracts are also obtained from other fruit and vegetable materials such as pomegranates, green coffee beans, tea leaves, raspberry fruit and leaves, strawberries, blueberries, and many other fruits and vegetable sources.

One common measurement (and alternative to the GAE measurement) for the amount of antioxidants present in a beverage is the “Oxygen Radical Absorbance Capacity” or ORAC value. It is measured in units of micromoles Trolox® [6-hydroxy-2,5,7,8-tetramethylchroman-2-carboxylic acid] per gram of beverage being assayed, where one ORAC unit corresponds to one micromole of Trolox®, a water-soluble analog of vitamin E.

In recent years, the scientific literature has suggested that different species of polyphenolic molecules can exhibit different biochemical properties and provide different health benefits when consumed regularly in the human diet. It has also been appreciated that a great diversity exists among polyphenolic molecular species synthesized in different varieties of grapes, and even within the same grape variety harvested at different times of the season (and presumably within their seeds).

It is believed that by combining the great variety of polyphenolic antioxidants from grape seeds and teas, for example, the health benefit obtained from the combination is greater than that of either separately. It is contemplated that in some instances, the antioxidants from tea and grape seed be combined, e.g., in approximately equal proportions based upon their polyphenolic antioxidant activities as measured in ORAC or GAE units.

The concept that a diversity and balance between the glycosylated and aglycone polyphenols is also desirable. For example, with acai berries, Del Pozo-Insfran et al., J. Agric. Chem. (2006) 54(4):1222-1229 demonstrated that the glycosylated forms of polyphenolic acids and flavanols were more potent in affecting leukemia cell proliferation and cell death in culture than aglycone forms.

Definitions

In the context of the present invention and the associated claims, the following terms have the following meanings:

The term “pro-oxidant” refers to a substance that can produce oxygen byproducts of metabolism that can cause damage to cells. That is, pro-oxidants are chemicals that induce oxidative stress, either through creating reactive oxygen species or inhibiting antioxidant systems. The oxidative stress produced by these chemicals can damage cells and tissues. Likewise, a “pro-oxidant” is a substance such as an ingested chemical or food ingredient or a substance or metabolite produced within the body (e.g., in response to sugar ingestion) that has a physiological or biochemical effect on the body that may be ameliorated or modified by ingestion of an antioxidant agent. Thus, “pro-oxidant sugars” are sugars which exert a pro-oxidant effect when ingested by normal humans.

The terms “dry edible sugar-based sweetener composition” refers to a mixed dry composition that includes both a dry sugar in granular or powdered form combined with a dry water-soluble polyphenolic antioxidant extract.

Similarly, the term “dry, edible pro-oxidant sugar and polyphenolic antioxidant mixture” refers to a dry mixture that includes a dry edible sugar that is a pro-oxidant when ingested by a human and an edible polyphenolic preparation, e.g., an extract from edible plant materials. Such a mixture is “balanced” is the ratio of polyphenolic antioxidant compounds to pro-oxidant sugar in the mixture is approximately within the range of such ratios for natural antioxidant rich edible plant materials. Preferably, the ratio is within a factor of two of the natural range, and in many cases is within the natural range.

As used herein, the term “sugar” includes monosaccharides e.g., fructose, glucose and galactose, as well as disaccharides, e.g., sucrose, lactose, and maltose, and combinations of any and all of these plus other sugar sweeteners. Pursuant to the U.S. FDA, the term “sugar” herein includes up to four linked monosaccharide units, as well as sugar alcohol derivatives (polyols) such as sorbitol, erythritol, glycerin, hydrogenated starch hydrolysates (HSH), isomalt, lactitol, maltitol, mannitol and xylitol that are low glycemic index sugars.

As used herein, the term “dry water-soluble polyphenolic antioxidant extract” refers to a dry extract derived from edible plant material (e.g., prepared from edible fruit and/or vegetable material) that dissolves in water, preferably in both hot and cold water, to provide a solution, and that contains high levels of polyphenolic antioxidants. In this context, the term “high levels” means that based upon water-soluble phenolic compounds whose concentrations are measured as gallic acid equivalents using the Folin-Ciocalteau reagent, the dry extract contains at least 30% by weight and preferably at least 50% by weight phenolic compounds. Moreover, the ratio of phenolic compounds to sugar in the sugar-based sweetener composition is preferably between 0.5% and 10% by weight. In this context, the term “extract” means a concentrated preparation of one or more active constituents a source material(s). Often the preparation of the extract involves the use of a solvent or solvents to enrich or purify the desired active constituents.

The term “sugar substitute” composition as used herein refers to edible non-sugar sweetener compositions. Non-sugar sweeteners approved for commercial use in the U.S. currently include saccharin, aspartame, sucralose, neotame, and acesulfame potassium. The herbal derivative known as stevia is also considered a sugar substitute.

The term “substantially caffeine-free” as it refers to the sweetener compositions herein means that no caffeine is added to the sweetener compositions and that the extract used for providing phenolic antioxidants is purified from a caffeine-free plant material or a decaffeinated plant material. Thus, for example, conventional fruit antioxidant extracts are caffeine-free, while Camellia sinensis tea extract and green coffee bean extract contain caffeine and, if used to provide a portion of the phenolic antioxidants, can be decaffeinated during their purification.

The term “fruit and/or vegetable material” within the context of the present invention refers to any edible and/or non-toxic plant, fruit or vegetable-derived material such as portions of dried fruits, their seeds, skins, interior pulps, plant leaves such as Camellia sinensis tea leaves, plant roots, herbal tea ingredients, beans, e.g., green or roasted coffee beans, cocoa beans, processed cocoa and chocolate-containing compositions and the like that can be extracted to produce a polyphenolic extract.

The term “infusion” as used herein refers to any drinkable/potable water-containing liquid that is prepared by brewing the beverage with hot water (water at a temperature of between approximately 140° F. and 212° F.) for a time sufficient to extract a desired amount of flavor and beneficial nutrients from the vegetable material. For example, traditional Camellia and herbal teas are typically steeped or brewed in hot water for between 2 minutes and 10 minutes using between 1 g and 2 g of dried tea (vegetable) material per 6-8 ounce serving. On the other hand, coffee-type infusion beverages are typically prepared using 5-10 g of ground roasted coffee beans per 6-8 ounce serving. Hot chocolate or cocoa-type infusion beverages contain processed cocoa powder, and may contain fresh or powdered milk as well as water. Milk, cream, and other ingredients of animal origin may be added to such infusions and to “vegetable-based compositions” of the present invention without exceeding the intended scope of the present invention. While serving size may vary among different hot water infusion beverages, for the purposes of this invention, a serving size is considered to be between approximately 1 and 10 ounces. For example a shot of espresso is approximately one fluid ounce, while a serving of tea may be as large as ten fluid ounces.

The term “phenolic antioxidant concentration” as used herein refers to the percentage by weight of water-soluble phenolics. This concentration is determined and expressed as gallic acid equivalents or GAE units that are equivalent to a percentage by weight of gallic acid. A phenolic or polyphenolic antioxidant concentration is measured using the Folin-Ciocalteau colorimetric assay based upon reacting these antioxidant compounds with the Folin-Ciocalteau reagent (abbreviated “F-C reagent”). The assay employs a gallic acid standard solution (1.00 mg/ml) that is used to generate a linear standard curve. Increasing amounts of the gallic acid solution (between 2.5 and 15 μl) are diluted into a series of sample test tubes holding 0.50 ml water. Next, 50 μl of F-C reagent (Sigma Chemical Company) is added to each tube. After 1 minute, but before 8 minutes following addition of the F-C reagent, 0.25 ml of a 15% by weight aqueous sodium carbonate solution is added, the samples are vortexed, and then incubated (maintained) for 2 hours at room temperature. The optical absorbance at 760 nm is read. A sample that is constituted with all chemical components but without gallic acid is also incubated as used as a blank sample to zero the sprectrophotometer (Spectronic 20D+ manufactured by Thermoelectron Corp.). This blank registered an absorbance (optical density or O.D.) at 760 nm of approximately 0.005 above that of distilled water. In the assay, an O.D. 760 nm reading of 1.3-1.4 corresponded to approximately 10 μl of 1.00 mg/ml gallic acid. Also, for reference purposes, a commercial single strength Concord 100% grape juice (Welch's) was shown to have the equivalency in the F-C assay of approximately 0.25% gallic acid (0.25 GAE units per 100 g juice).

For the purposes of this invention, the term “polyphenolic antioxidants” (aka “phenolic antioxidants”) and the measured concentrations thereof includes any phenolic compound that is present. The chemical assay of phenol chemical groups using the F-C reagent does not distinguish between simple phenolic derivative compounds and more complex polyphenolic structures. For the purposes herein, polyphenolic antioxidants represent all of the phenolic group molecular species (molecular structures) that remain soluble in a juice, e.g., following pressing, filtering and packaging of an anthocyanin-rich grape juice, a colorless (white) grape juice, tea, other juice, or other precursor edible product, for example. These polyphenolic antioxidants can include some molecules that have already undergone a limited amount of oxidation and/or polymerization due to exposure to air, light.

Polyphenolic compounds protect plants from pathogens, serve as UV sunscreens, and can repel hungry animals. As antioxidants, the phenolics can scavenge unpaired electrons (free radicals), inactivate reactive oxygen species, and chelate metal ions that catalyze oxidation. A partial list of prevalent phenolic species include the simple cinnamic and benzoic acid derivatives, the stilbenes (2 phenolic rings), the 3 ring flavonoids (2 phenolic rings plus a flavone ring) that include catechins, flavanols, the anthocyanidins (not glycosylated) and the positively charged anthocyanins of many different structures (glycosylated anthocyanidins having colors ranging from red to blue), and the four ring ellagic acid species and its derivatives as well as a variety of tannins, to name a few.

The term “shelf life” or “shelf-stable” in the context of grape seeds and polyphenolic antioxidant extracts refers to a loss of less than 25% per year in the polyphenolic antioxidant content of the material when stored at 20° C.

A non-exclusive list of grape species that can used as a source of grape seeds as well as antioxidant extracts from skins, seeds and/or pulp includes Vitis labrusca (Concord), Vitis rotundifolia (Muscadine), Vitis vinifera (European wine grape) and combinations of these.

A “beverage” is defined as any one of various compositions that are pourable liquids for drinking either hot, at room temperature or refrigerated. Illustrative beverages include fruit juice, vegetable juice, tea, coffee, and the like.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, as a source of phenolic antioxidants, in addition to grape seed extract, other dry, water-soluble fruit and/or vegetable-derived extracts not listed herein, may be incorporated into the compositions described herein, and used in combinations and concentrations not described herein, to produce phenolic antioxidant-enriched sweeteners that fall within the scope of the present invention. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Unless otherwise defined herein, all terms have their ordinary meanings as understood by one of ordinary skill in the field to which the invention pertains. The use of the article “a” or “an” is intended to include one or more.

Thus, additional embodiments are within the scope of the invention and within the following claims.

What is claimed is:

1. A dry, edible, balanced pro-oxidant sugar and polyphenolic antioxidant mixture, consisting essentially of
a first quantity of at least one granular or powdered sugar comprising sucrose or fructose or both; and
at least one dry water-soluble extract purified from edible plant material containing a second quantity of complex polyphenolic antioxidants, wherein the ratio of said second quantity to said first quantity is within the range of ratios of complex polyphenolic antioxidants to sugars in antioxidant-rich edible plant materials.

2. The balanced pro-oxidant sugar and polyphenolic antioxidant mixture of claim 1, wherein said ratio is from 0.5% to 10% by weight.

3. The balanced pro-oxidant sugar and polyphenolic antioxidant mixture of claim 1, wherein said ratio is from 1% to 5% by weight.

4. The balanced pro-oxidant sugar and polyphenolic antioxidant mixture of claim 1, wherein said extract is derived from fruit.

5. The balanced pro-oxidant sugar and polyphenolic antioxidant mixture of claim 1, wherein at least 50% by weight of said polyphenolic antioxidants consist of monomeric and polymeric proanthocyanidin molecules.

6. The balanced pro-oxidant sugar and polyphenolic antioxidant mixture of claim 1, wherein said extract contains at least 50% by weight polyphenolic anti oxidants.

7. The pro-oxidant sugar and polyphenolic antioxidant mixture of claim 1, wherein said mixture is pre-measured and packaged in single serving packages containing from 3 g to 10 g per package.

8. A dry, edible, balanced pro-oxidant sugar and polyphenolic antioxidant mixture, consisting essentially of
a first quantity of at least one sugar; and
a second quantity of polyphenolic antioxidants provided by at least one dry water-soluble extract purified from edible plant material; and
optionally no more than 5% by weight of a sugar substitute sweetener, wherein the ratio of said second quantity to said first quantity is between 0.5% and 10% by weight.

9. The pro-oxidant sugar and polyphenolic antioxidant mixture of claim 8, wherein said extract is purified from fruits or vegetables or both.

10. The pro-oxidant sugar and polyphenolic antioxidant mixture of claim 8 wherein at least 50% by weight of said polyphenolic antioxidants consist of monomeric and polymeric proanthocyanidin molecules.

11. The pro-oxidant sugar and polyphenolic antioxidant mixture of claim 8 wherein said composition is substantially caffeine-free.

12. The pro-oxidant sugar and polyphenolic antioxidant mixture of claim 8 wherein said at least one dry water-soluble extract contains at least 90% by weight polyphenolic antioxidants.

13. The pro-oxidant sugar and polyphenolic antioxidant mixture of claim 8, wherein said ratio by weight is between 0.5% and 5%.

14. The pro-oxidant sugar and polyphenolic antioxidant mixture of claim 8, wherein said at least one dry water-soluble extract is prepared from fruits or vegetables or both selected from the group consisting of fruit berries, fruit pomace, fruit seeds, fruit skins, Camellia sinensis leaves, and combinations thereof.

15. The pro-oxidant sugar and polyphenolic antioxidant mixture of claim 8, wherein said composition is pre-measured and packaged in single serving packages containing from 3 g to 10 g per package.

16. The pro-oxidant sugar and polyphenolic antioxidant mixture of claim 8, wherein said sugar comprises sucrose or fructose.

17. The composition of claim 8, wherein said sugar substitute is selected from the group consisting of sucralose, saccharin, aspartame and combinations thereof.

18. A method for reducing the oxidizing effects of a pro-oxidant sugar, comprising
forming a mixture consisting essentially of a first quantity of a sugar-based sweetener and an extract from edible plants, wherein said extract contains a second quantity of polyphenolic antioxidants and wherein the ratio of said second quantity to said first quantity is from 0.5% to 10% by weight.

19. The method of claim 18, wherein said sugar-based sweetener consists essentially of sucrose, fructose, or both.

20. The method of claim 18, further comprising ingesting said mixture.
